(19) United States
(12) Patent Application Publication
(10) Pub. No.: US 2003/0006356 A1
(43) Pub. Date: Jan. 9, 2003

(54) Stand for gripping rod-shaped components

(76) Inventor: Klaus Krinner, Strasskirchen (DE)

Correspondence Address: JORDAN AND HAMBURG LLP, 122 East 42nd Street, New York, NY, 10168, US

(21) Appl. No.: 09/730,231

(22) Filed: Dec. 5, 2000

(30) Foreign Application Priority Data
Dec. 16, 1999 (DE) 199 60 852.0

(51) Int. Cl. F16M 13/00

(52) U.S. Cl. 248/523

(57) ABSTRACT

The invention relates to a stand for gripping rod-shaped components, in particular Christmas trees. The stand is formed in two pieces from a housing cover and a housing base. A recess for a holding region and for a clamping and retaining device is provided in the housing cover. With the housing cover placed onto it, the housing base forms a chamber for holding a hardening filling material which can be poured into it.

Stand for gripping rod-shaped components The invention relates to a stand for gripping rod-shaped components, in particular Christmas trees, the housing of the stand consisting of two parts, a housing cover and a housing base.

A large number of stands for gripping rod-shaped components has already been disclosed in the prior art, which also includes a number of patents and utility models by the applicant himself (for example, EP-A 0 419 972, DE 297 06 959, DE 39 32 473 etc.). Until now, the development and design of stands of this type concentrated primarily on the problem of how to grip and fix the rod-shaped components in the stand and on the means which can be used for this. At the same time, stands of this type also have to be very steady. In contrast to earlier models of stands for rod-shaped components, which have virtually exclusively been produced from metal, use is made nowadays predominantly of plastic which is cheaper and easier to process, but which, of course, has a lower density than metal or, for example stone, and accordingly is unable to provide the necessary stability and steadiness. In order nevertheless to ensure a certain steadiness for plastic stands, known stands of this type have, with increased use of material, been made with particularly thick walls, which causes correspondingly higher production costs. Moreover, in the case of the two-part design of stands, i.e. when the housing base and housing cover are produced separately from each other, there is the problem of keeping the two housing parts connected securely together using suitable means.

The object of the present invention is therefore to provide a stand which is very steady and has high dimensional stability, but which at the same time can also be produced simply and cost-effectively.

According to the invention, this object is achieved by a stand having the features according to claim 1. Preferred embodiments of the stand according to the invention are specified in the dependent claims.

The stand according to the invention for gripping rod-shaped components has a two-part housing having a housing base and a housing cover. A recess for a holding region of a rod-shaped component and for a clamping and retaining arrangement is provided in the housing cover. When placed one onto the other, the housing base and the housing cover form a chamber which is provided for holding a filling material which can be poured therein and then hardens. The two-part housing of the stand, which simultaneously, by putting the housing cover and housing base together, also forms the chamber provided for the filling material, can be produced simply and cost-effectively by the manufacturing process. Since the chamber is filled with hardening filling material, which also ensures the necessary stability and strength of the stand, the housing walls of the stand can be made such that they are relatively thin. Less plastic is therefore required for producing the stand, and in addition, shorter cycle times during production can be achieved.

The housing cover and the housing base are preferably produced from plastic. In a further preferred embodiment, the filling material poured into the chamber has a greater density than water under normal conditions. It is advantageous if the filling material is clearly heavier than water and consists of concrete or gypsum which hardens rapidly. The high density of concrete gives the stand the necessary stability and steadiness, when a rod-shaped component is gripped in it, by shifting the center of gravity in the direction of the standing surface of the stand. Moreover, the high density of the concrete makes it possible to make the walls of the housing base and housing cover very thin and nevertheless to ensure that the stand has good strength.

An expedient development resides in the fact that the housing cover when placed onto the housing base is separated off in a watertight manner from the chamber filled with filling material, with the result that the remaining interior space in the region of the recess, which space is not used as a chamber for hardening filling material and is formed by the housing cover and base, can be used as a water reservoir. This is particularly advantageous if the stand is used for gripping Christmas trees which are kept fresh over a prolonged period with the trunk in the water. With the thin-walled design of the housing, an increase in this water reservoir is also obtained at the same time, which has the advantage of not having to refill the fresh water as often.

In another preferred embodiment of the present invention, the housing base and the housing cover are connected releasably to each other by means of at least one connecting means, preferably by means of a screw. In order to configure the structural design of the stand simply even when additional connecting means are used, the screw guide is formed directly on a wall of the chamber filled with filling material. The releasable connection between the housing base and housing cover has the advantage that, for example in the event of a defect in one of the two housing parts, said part can be replaced in a simple manner.

In a further embodiment, a two-part latching arrangement is preferably provided as the connecting means between the housing base and housing cover, one of the two interacting parts of the latching arrangement being arranged in each case on the housing cover and housing base.

This connection is advantageously likewise easily re-releasable, so that rapid and simple replacement of defective parts is possible. Moreover, the connecting means are arranged in the housing and do not interfere with the external appearance of the stand.

According to a further preferred embodiment, both the housing cover and the housing base have respective connecting means in the form of securing elements. With the housing cover placed onto the housing base the connecting means protrude into the chamber and are completely enclosed by the filling material poured therein. The connecting means, after the filling material has hardened, therefore provide a firm, long-lasting and extremely stable and non-releasable connection between the housing base and the housing cover.

The connecting means are preferably manufactured in the form of securing elements made of plastic, the respective securing elements being formed integrally with the housing base and the housing cover, which likewise results in a reduction in the production costs. This is because additional connecting means are superfluous in this design. Moreover, the connection, provided by the connecting means when encapsulated by the filling material, between the housing base and housing cover is very stable and durable.

The invention is explained below by way of an embodiment and referring to the attached drawings, in which:

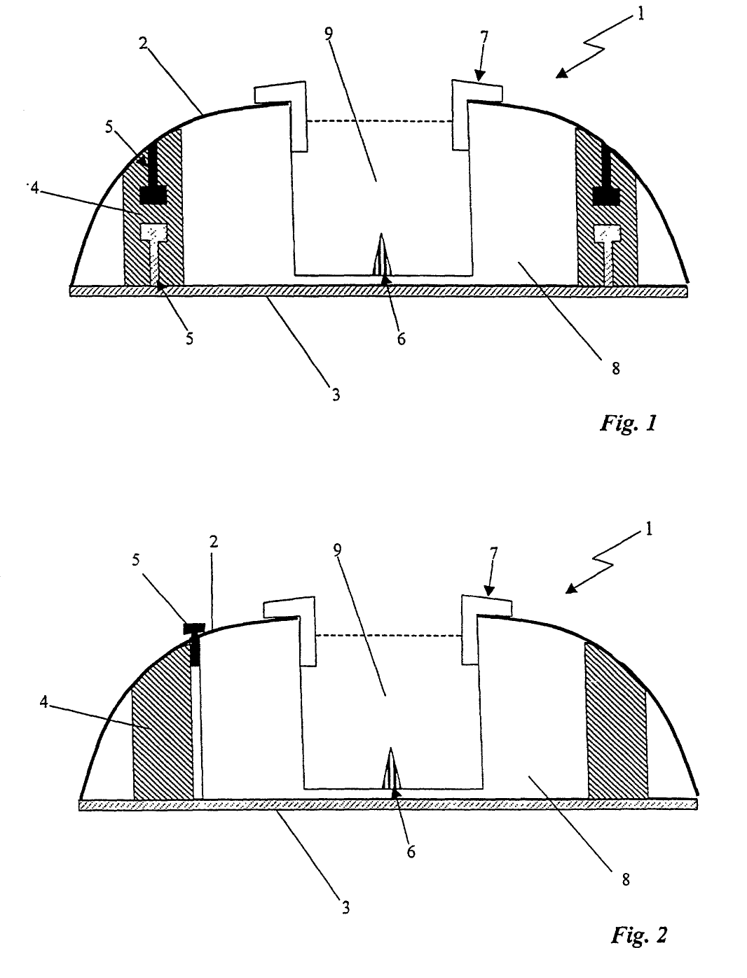

FIG. 1 shows a cross-sectional view through the stand according to the invention;

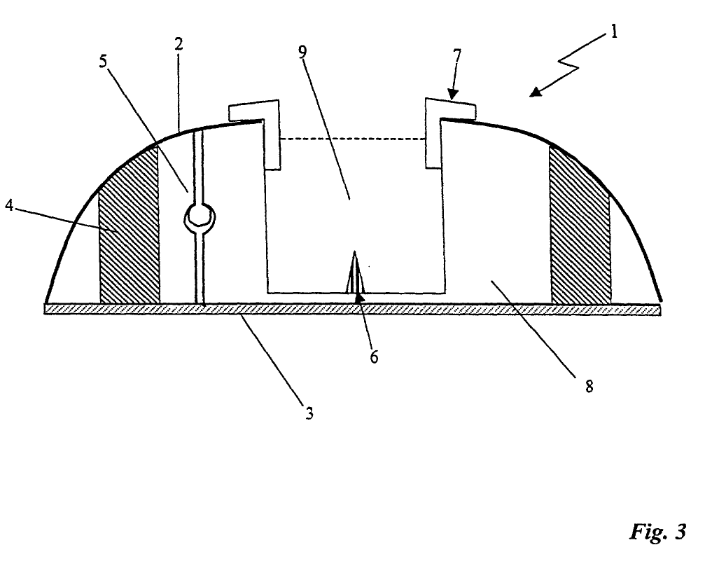

FIG. 2 shows a cross-sectional view through a further embodiment of the stand; and

FIG. 3 shows a cross-sectional view through another embodiment of the stand.

FIG. 1 illustrates a cross-sectional view of a stand 1 for gripping a rod-shaped component (not shown), for example, for gripping a Christmas tree. The housing base 3 has an essentially circular base surface. The housing cover 2, which is essentially in the form of half a shell, is placed onto the housing base 3, which results in the formation of a chamber 4. Connecting means 5 in the form of securing elements which project into the chamber 4 are arranged in each case on the housing cover 2 and on the housing base 3. The chamber 4 is filled with a hardening filling material, the filling material completely filling the chamber 4 and in doing so surrounding the connecting means 5, as a result of which the housing base 3 and the housing cover 2 are connected firmly to each other. The housing cover 2 has a recess in which there are provided a clamping and retaining arrangement 7 for clamping and retaining a rod-shaped component, and a holding region 9 for the latter. Arranged in the holding region 9 is a centering spike 6 as a place-on aid for the rod-shaped component, for example the trunk of a Christmas tree.

FIG. 2 illustrates a further embodiment of the stand 1 in cross section, in which the connection between the housing cover 2 and housing base 3 is releasable. As in the embodiment shown in FIG. 1, the chamber 4 is filled with concrete. The connection between the housing cover 2 and housing base 3 is produced by an additional connecting means 5. The connecting means 5 is a screw which is screwed directly adjacent to the chamber 4 into a thread provided for it. The thread is integrated in the side wall of the chamber 4, the side wall being formed integrally with the housing base 3.

FIG. 3 shows another embodiment of the stand 1 in cross section, in which the housing cover 2 and the housing base 3 are likewise connected releasably. The connecting means 5 here is provided by a two-part latching arrangement, a first part of the latching arrangement being arranged on the housing cover 2 and the second part of the latching arrangement, which engages in the first part, being arranged on the housing base 3. With the housing cover 2 placed onto the housing base 3 the latching arrangement is arranged in the interior of the housing formed in this manner and cannot be seen from the outside.

List of reference numbers

| | |
|---|---|
| 1 | Stand |
| 2 | Housing cover |
| 3 | Housing base |
| 4 | Chamber |
| 5 | Connecting means |
| 6 | Centering spike |
| 7 | Clamping and retaining device |
| 8 | Water reservoir |
| 9 | Holding region |

1. A stand (1) for gripping rod-shaped components, in particular Christmas trees, having a two-part housing consisting of a housing cover (2) and a housing base (3), a recess for a holding region (9) and for a clamping and retaining device (7) being provided in the housing cover, wherein with the housing cover (2) placed onto the housing base (3) a chamber (4) is provided for holding a hardening filling material which can be poured therein.

2. The stand as claimed in claim 1, wherein the housing cover (2) and the housing base (3) are made of plastic.

3. The stand as claimed in claim 1 or 2, wherein the filling material which is held in the chamber (4) has a greater density than water and is a rapidly hardening material, in particular concrete or gypsum.

4. The stand as claimed in one of claims 1 to 3, wherein the housing cover (2) when placed onto the housing base (3) is separated off from the chamber (4) in a watertight manner and forms a water reservoir (8) for holding a liquid.

5. The stand as claimed in one of claims 1 to 4, wherein the housing base (3) and the housing cover (2) are connected releasably to each other by at least one connecting means (5), in particular by a screw.

6. The stand as claimed in claim 5, wherein the connecting means (5) is arranged directly on a wall of the chamber (4) formed by the housing cover (2) and housing base (3).

7. The stand as claimed in claim 5 or 6, wherein the connecting means (5) is a latching arrangement which has at least two intermeshing parts which are provided in each case on the housing cover (2) and housing base (3).

8. The stand as claimed in one of claims 1 to 4, wherein the housing cover (2) and the housing base (3) have respective connecting means (5), the connecting means (5) being securing elements.

9. The stand as claimed in claim 8, wherein with the housing cover (2) placed onto the housing base (3) the connecting means (5) protrude into the chamber (4) and, encapsulated by the filling material, provide a firm connection of the housing cover (2) to the housing base (3).

10. The stand as claimed in claim 8 or 9, wherein the respective connecting means (5) are made of plastic and are formed integrally with the housing cover (2) and housing base (3).
